(19) United States
(12) Patent Application Publication
(10) Pub. No.: US 2007/0165371 A1
(43) Pub. Date: Jul. 19, 2007

(54) Portable digital media player case

(75) Inventor: Kyle Brandenburg, Plantation, FL (US)

Correspondence Address: LERNER GREENBERG STEMER LLP, P O BOX 2480, HOLLYWOOD, FL, 33022-2480, US

(73) Assignee: Marware, Inc.

(21) Appl. No.: 11/331,986

(22) Filed: Jan. 13, 2006

(51) Int. Cl. A45C 1/04; G06F 1/16; B65D 85/00

(52) U.S. Cl. 361/683; 206/701; 224/930; 224/666

(57) ABSTRACT

A portable digital media player case includes a front surface having at least one viewing window, a rear surface opposite the front surface, side surfaces and top and bottom surfaces. A winder is movable into and out of one of the surfaces, preferably the rear surface, between a closed storage position and an open position for receiving a cord.

### BACKGROUND OF THE INVENTION

1. Field of the Invention

The invention relates to a case for accommodating a portable digital media player, such as an Apple iPod.

2. Description of the Related Art

The tremendous growth in sales of portable digital media players has led to the development of many accessories which accommodate components of the various devices and generations thereof, such as the Apple iPod. Such accessories include cases which protect the iPod from shock, make it easier to grip and have openings for components of the device, such as to allow a cord of headphone earbuds to be plugged in.

One such case produced by Marware is formed of neoprene and has a large opening for the display screen and click wheel and a flip-top. Another neoprene case produced by Incase has separate openings for the display screen and click wheel and a zipper closure. Neoprene fits loosely around the iPod and does not follow the contour thereof.

A case which is manufactured by Speck is formed of KRATON® and has a dimpled exterior and an opening for various ports on the iPod. Silicone rubber cases made by iSkin, Xtreme Mac and Elecom fit tightly over the iPod and have separate openings for the display screen and the click wheel. Such cases are difficult to pull on and off the iPod. The Elecom case has a winder projection at the side for winding an earbud headphone cord. None of those prior art cases is easy to put on and take off the iPod, fits snugly around the iPod, protects the iPod from shock, and yet also provides a winding region for the earbud headphone cord which does not enlarge the dimensions of the case and which is unobtrusive when retracted.

Several rigid cases are distributed under the names XtremeMac Shieldz, iPod Armor, Contour Showcase, Agent 18 Mini Shock and Macally IceCase. All of those cases are formed of rigid plastic, except for the iPod Armor which is formed of aluminum. None of those cases has a winding location for an earbud headphone cord.

### SUMMARY OF THE INVENTION

It is accordingly an object of the invention to provide a portable digital media player case, which overcomes the hereinafore-mentioned disadvantages of the heretofore-known devices of this general type, which fits snugly, which protects against shock, which is easy to use and which has a winder for a headphone cord that retracts fully into the case and is unobtrusive when not in use.

With the foregoing and other objects in view there is provided, in accordance with the invention, a portable digital media player case. The case comprises a front surface having at least one viewing window, a rear surface opposite the front surface, side surfaces and top and bottom surfaces. A winder is movable into and out of one of the surfaces between a closed storage position and an open position for receiving a cord. When retracted, the winder is unobtrusive and virtually disappears into the case.

In accordance with another feature of the invention, preferably the one surface with the winder is the rear surface. The side of the iPod has no docks, switches or ports, so that it is the preferred location for the winder.

In accordance with a further feature of the invention, the winder has at least one leg for sliding into and out of at least one channel formed in the rear surface between the closed storage position and the open position. Two legs preferably slide into and out of two channels formed in the rear surface. Although one leg is sufficient, two are more stable and provide a wider winding spool. The legs have prongs for gripping surfaces of the channels and retaining the winder in place. In this way, the mechanism for extending and retracting the winder is also free of protrusions extending beyond the plane of the surface of the case.

In accordance with an added feature of the invention, the rear surface has a given shape and has a recess formed therein contiguous with the channels. The winder has a handle integral with the legs. The handle has an outer surface contoured to match the given shape. The handle is received in the recess with the outer surface of the handle being flush with the rear surface, when the winder is in the closed storage position. The winder also has a finger grip formed therein. Whether curved or angular, the winder merges completely into the case when in the closed position and is hardly noticeable when being handled during use.

In accordance with an additional feature of the invention, the winder has at least one slot formed therein for receiving the headphone cord when in the open position. This feature prevents the cord from unraveling.

In accordance with yet another feature of the invention, there are provided front and rear panels forming two half shells. The front panel has the front surface and part of the side surfaces and the rear panel has the rear surface and part of the side surfaces. The front and rear panels are joined at a parting line. The front and rear panels each form part of the bottom surface. An upper panel having the top surface slides in grooves formed in the front and rear panels and has a finger grip formed therein. The two half shells snap together. The upper panel slides open and makes it very easy to put the portable digital media player into the case from the top.

In accordance with yet a further feature of the invention, the upper panel has at least one opening formed therein for accessing components of the portable digital media player. At least one of the front and rear panels has at least one opening formed therein at the bottom surface for accessing components of the portable digital media player.

Naturally, the location of the holes will change to accommodate the particular device to be placed in the case.

In accordance with yet an added feature of the invention, there is provided a mounting disposed at the rear panel for attachment of a belt clip. Such mountings are conventional and are known, for example, from cell phone cases.

In accordance with yet an additional feature of the invention, there is provided a cover closing the at least one opening at the bottom surface. The cover is used, in particular, for covering and protecting a docking port.

In accordance with a concomitant feature of the invention, the front and rear panels are formed of rigid plastic. This material protects the portable digital media player from shock.

Other features which are considered as characteristic for the invention are set forth in the appended claims.

Although the invention is illustrated and described herein as embodied in a portable digital media player case, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a diagrammatic, front-elevational view of a portable digital media player case according to the invention;

FIG. 2 is a top-plan view of the case of the invention;

FIG. 3 is a bottom-plan view of the case of the invention;

FIG. 4 is a left side-elevational view of the case of the invention;

FIG. 5 is a right side-elevational view of the case of the invention, showing a winder in a closed storage position;

FIG. 6 is a rear-elevational view of the case of the invention, in which the winder is shown in the closed storage position;

FIG. 7 is a view similar to FIG. 2, in which the winder is shown in an open position;

FIG. 8 is a view similar to FIG. 1, in which the winder is shown in the open position;

FIG. 9 is a view similar to FIG. 6, in which the winder is shown in the open position;

FIG. 10 is a front and right side perspective view of the case of the invention with the winder in the open position and an earbud cord wrapped around the winder;

FIG. 11 is a rear and right side perspective view of the case of the invention with the winder in the open position and a belt clip attached;

FIG. 12 is an exploded view of the case of the invention; and

FIG. 13 is a rear, top and left-side perspective view of the case of the invention showing a stand at the rear.

### DESCRIPTION OF THE PREFERRED EMBODIMENTS

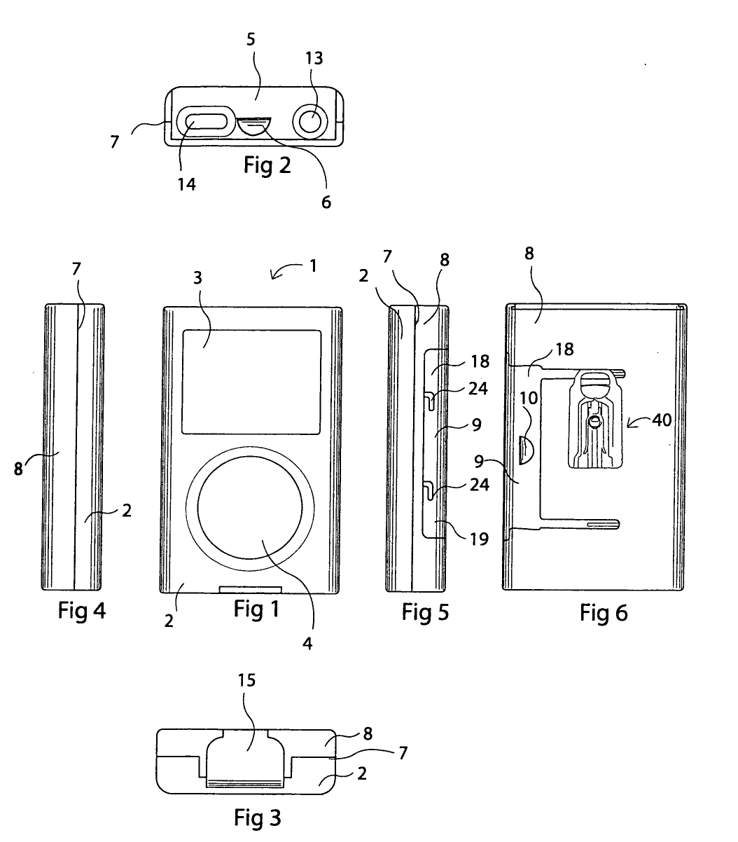

Referring now to the figures of the drawings in detail and first, particularly, to FIG. 1 thereof, there is seen a case 1 for a portable digital media player, such as an Apple iPod. The case 1 has a front panel 2 defining a front surface in which a window 3 for a display screen and a window 4 for a click wheel of the portable digital media player are formed as cutouts. A rear panel 8 of the case, which is illustrated in FIG. 6, defines a rear surface that accommodates a winder 9 which will be explained in more detail below. The case may be formed of rigid plastic, a rigid or flexible clear panel may be placed in the window 3, but the window 4 normally remains an open cutout.

FIG. 2 shows an upper panel 5 of the case 1 defining an upper surface having an opening 13 for a headphone port and a slot 14 for a hold switch, of the iPod. The upper panel 5 also has a finger grip 6 for removing the panel 5. FIG. 3 shows the bottom of the case 1 defining a bottom surface having a cover 15 with a live hinge for covering an opening 29 above a dock connector port of the iPod. It is understood, however, that other openings, covers and/or windows may be formed in the case to accommodate components of any generation iPod or other digital media player.

It may be seen from the left and right sides of the case which define side surfaces and are respectively illustrated in FIGS. 4 and 5, as well as from FIGS. 2 and 3 described above, that both the front panel 2 and the rear panel 8 wrap around to the sides and the bottom and are joined at a parting line 7. The parting line 7 divides the case into two half shells formed of the front panel 2 and the rear panel 8.

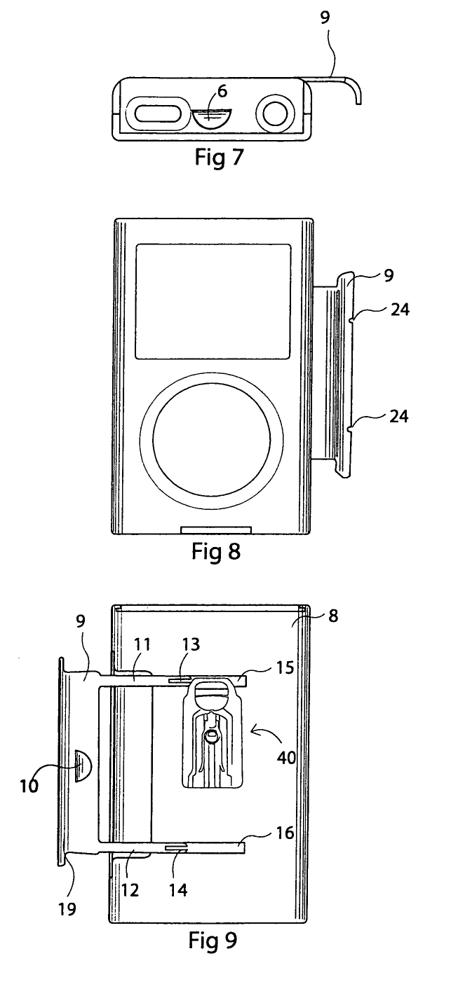

The winder 9, which is shown in FIGS. 5 and 6 in a closed storage position, is shown in FIGS. 7, 8 and 9 in an open position. The winder 9 has a finger grip 10 which facilitates sliding the winder from the closed to the open position. The winder 9 has two legs 11, 12 with respective forked prongs 13, 14. The legs 11, 12 slide in respective channels 15, 16 in the rear panel 8 to open and close the winder 9 toward the right side of the case while the prongs grip surfaces in the channels. It is, however, understood that the winder could also open towards the left side or towards any surface not having openings to accommodate components of the digital media player. It is also understood that only one leg and only one channel or more than two legs and more than two channels could be provided.

The rear panel 8 also has a recess 17 formed therein which is contiguous with the channels 15, 16. The recess 17 receives a handle 18 of the winder 9. The handle 18 has an outer surface 19 which is contoured to match a given shape of the rear panel 8, so that when the winder is retracted in the closed storage position, the outer surface 19 of the handle 18 is flush with the rear panel 8, as is seen in FIGS. 5 and 6.

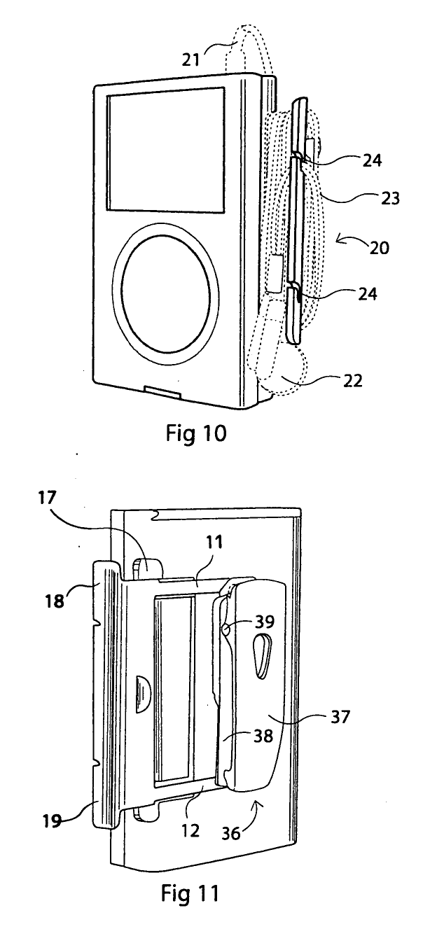

FIG. 10 discloses that earbud headphones 20 have a plug 21 to be inserted in the opening 13 and a cord 23 to be wrapped around the winder 9 when in the open position. Earbuds 22 on the cord 23 are held in place by inserting the cord 23 into one or two slots 24 formed in the winder 9.

As is seen in FIG. 11, a belt clip 36 is conventionally removably mounted on the rear panel 8 between the legs 11, 12 of the winder 9. The belt clip 36 has an outer arm 37 and an inner arm 38 pivoted about a pin 39 having a non-illustrated spring for biasing the arms together to grip a belt. A mounting 40 is disposed in the rear panel 8 for attachment of the belt clip 36, as is seen in FIG. 9. The clip and mounting are manufactured by Krusell under the designation MULTIDAPT®.

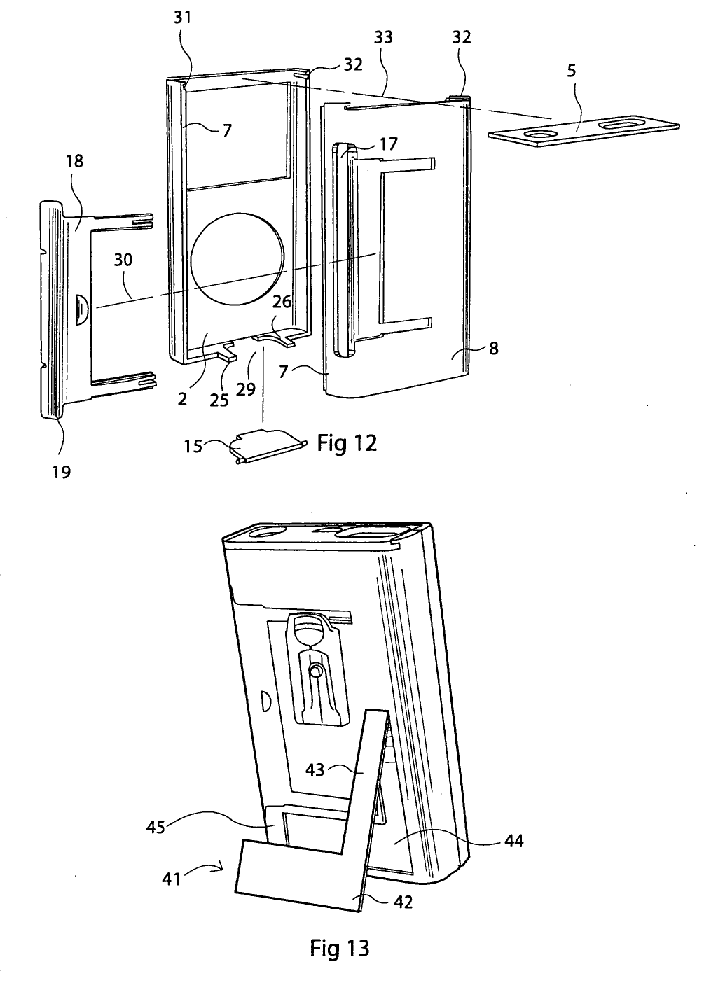

FIG. 12 is an exploded view of the case 1 illustrating how the two panels 2, 8 come together at the parting line 7 with prongs 25, 26 disposed alongside the panel 5 as seen in FIG. 3. It may also be seen that the legs 11, 12 of the winder 9 slide into and out of the channels 15, 16 along a line 30 and that the upper panel 5 slides along grooves 31, 32 in the panels 8, 2 along a line 33 for insertion of the portable digital media player.

FIG. 13 shows an L-shaped stand 41 having a short leg 42 and a long leg 43. A recess 44 has a shape matching that of the stand 41 so that the stand 41 can be pushed and snapped into the recess 44 for storage or hinged at the top into the position shown for allowing the case to stand at a slight incline, but substantially upright, on a flat surface. A bevel 45 allows the user of the case to lift the stand 41 out of the recess 44 with a finger.

The invention provides a rigid case for preventing shocks from reaching the digital media player. The case can be easily snapped together at the parting line. The winder 9 may receive the cord 23 in an open position or be stored in a closed position when not in use, so that it is unobtrusive and virtually disappears into the case.

I claim:

1. A portable digital media player case, comprising:
a front surface having at least one viewing window;
a rear surface opposite said front surface;
side surfaces;
top and bottom surfaces; and
a winder movable into and out of one of said surfaces between a closed storage position and an open position for receiving a cord.

2. The case according to claim 1, wherein said one of said surfaces is said rear surface.

3. The case according to claim 2, wherein said winder has at least one leg for sliding into and out of at least one channel formed in said rear surface between said closed storage position and said open position.

4. The case according to claim 3, wherein said at least one leg is two legs for sliding into and out of two channels formed in said rear surface.

5. The case according to claim 2, wherein said rear surface has a given shape, and said winder has an outer surface contoured to match said given shape.

6. The case according to claim 4, wherein said rear surface has a given shape, said rear surface has a recess formed therein contiguous with said channels, said winder has a handle integral with said legs, said handle has an outer surface contoured to match said given shape, and said handle is received in said recess with said outer surface of said handle being flush with said rear surface, when said winder is in said closed storage position.

7. The case according to claim 1, wherein said winder has at least one slot formed therein for receiving the headphone cord when in said open position.

8. The case according to claim 2, which further comprises front and rear panels forming two half shells, said front panel having said front surface and part of said side surfaces and said rear panel having said rear surface and part of said side surfaces, said front and rear panels being joined at a parting line.

9. The case according to claim 8, wherein said front and rear panels each form part of said bottom surface.

10. The case according to claim 8, which further comprises an upper panel having said top surface.

11. The case according to claim 10, wherein said upper panel slides in grooves formed in said front and rear panels and said upper panel has a finger grip formed therein.

12. The case according to claim 11, wherein said upper panel has at least one opening formed therein for accessing components of the portable digital media player.

13. The case according to claim 8, wherein at least one of said front and rear panels has at least one opening formed therein at said bottom surface for accessing components of the portable digital media player.

14. The case according to claim 6, which further comprises front and rear panels forming two half shells, said front panel having said front surface and part of said side and bottom surfaces and said rear panel having said rear surface and part of said side and bottom surfaces, said front and rear panels being joined at a parting line, and an upper panel having said top surface.

15. The case according to claim 1, wherein said winder has a finger grip formed therein.

16. The case according to claim 4, wherein said legs have prongs for gripping surfaces of said channels.

17. The case according to claim 8, which further comprises a mounting disposed at said rear panel for attachment of a belt clip.

18. The case according to claim 13, which further comprises a cover closing said at least one opening at said bottom surface.

19. The case according to claim 8, wherein said front and rear panels are formed of rigid plastic.

20. The case according to claim 14, wherein said upper panel slides in grooves formed in said front and rear panels for insertion and removal of the portable digital media player.

21. The case according to claim 1, which further comprises a stand for supporting the case in a substantially upright position.
